(19) United States
(12) Patent Application Publication
(10) Pub. No.: US 2006/0084474 A1
(43) Pub. Date: Apr. 20, 2006

(54) Method and system for managing a cell sectorized by both an angle in azimuth and a distance from a base station

(75) Inventors: Ana Lucia Iacono, Garden City, NY (US); Bing A. Chiang, Melbourne, FL (US); Michael James Lynch, Merritt Island, FL (US); Steven Jeffrey Goldberg, Downingtown, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/066,349

(22) Filed: Feb. 25, 2005

Related U.S. Application Data
(60) Provisional application No. 60/619,676, filed on Oct. 18, 2004.

(51) Int. Cl. H04M 1/00

(52) U.S. Cl. 455/562.1

(57) ABSTRACT

A method and system for managing a cell sectorized by both an angle in azimuth and a distance from a base station are disclosed. A wireless communication system comprises a base station and a cell. The base station comprises an antenna array for generating a plurality of directional beams which are steerable both in azimuth and elevation. The cell is sectorized into a plurality of sectors defined in accordance with an angle in azimuth and a distance from the base station. At least one directional beam serves each sector. Beams serving adjacent sectors overlap each other, and a softer handover in a cell is performed in the overlapping region.

### CROSS REFERENCE TO RELATED APPLICATION

This application claims the benefit of U.S. Provisional Application No. 60/619,676 filed Oct. 18, 2004 which is incorporated by reference as if fully set forth.

### FIELD OF INVENTION

The present invention is related to a wireless communication system. More particularly, the present invention is a method and system for managing a cell sectorized in two-dimensions in a wireless communication system.

### BACKGROUND

Capacity is one of the most important issues in wireless communication systems. One way to enhance capacity of a wireless communication system having a plurality of cells is to utilize a directional beam antenna along with sectorizing the cell. FIG. 1 shows an example of a three-sector cell where the cell is divided in azimuth. In most wireless communication systems, a cell, i.e., the geographical region served by a single base station, (shown as BS), is typically further divided into a plurality of sectors. The base station which serves the cell is equipped with a smart antenna or array antenna which generates a plurality of directional beams. Typically, a cell is divided into three (3) sectors, and each directional beam covers one sector.

In order to allow for softer handover between adjacent sectors in a cell, adjacent directional beams are positioned to overlap each other. This is shown in FIG. 2 for the case of a three-sector cell. A wireless transmit/receive unit (WTRU) in an overlapped region receives signals simultaneously from two adjacent beams and as the WTRU moves across the overlapped region, a communication is handed over from one sector to the other sector.

It would be beneficial if a cell were to be further sectorized with respect to the distance from the base station, (which generates a plurality of concentric sectors around the base station), in addition to being sectorized in azimuth. In that case, further enhancement of the capacity of wireless communication systems is possible. However, sectorization of a cell in two-dimensions has not been disclosed in prior art. Accordingly, there is a need for a method and system for two-dimensional sectorization of a cell.

### SUMMARY

The present invention is a method and system for managing a cell that is sectorized by both an angle in azimuth and a distance from a base station. A wireless communication system incorporating the present invention utilizes a base station and a cell. The base station comprises an antenna array for generating a plurality of directional beams which are steerable both in azimuth and elevation. The cell is sectorized into a plurality of sectors defined in accordance with an angle in azimuth and a distance from the base station. At least one directional beam serves each sector. Beams serving adjacent sectors overlap each other, and a softer handover is performed in the overlapped region.

### BRIEF DESCRIPTION OF THE DRAWINGS

FIG. 1 is a diagram of a prior art cell sectorized in azimuth.

FIG. 2 is a diagram showing beam overlapping for softer handover in the prior art cell shown in FIG. 1.

FIG. 3 is a diagram of a cell sectorized by the distance from a base station in accordance with the present invention.

FIG. 4 is a block diagram of a base station operating in a cell sectorized in two-dimensions in accordance with the present invention.

FIG. 5 is a diagram of a cell sectorized in two-dimensions in accordance with the present invention.

FIG. 6 is a diagram of a sectorized cell with softer handover regions in a cell shown in FIG. 5.

FIGS. 7A and 7B are diagrams showing beams overlapping both in azimuth and elevation for softer handover in accordance with the present invention.

FIG. 8 is a flow diagram of a process for managing a cell sectorized in two-dimensions in accordance with the present invention.

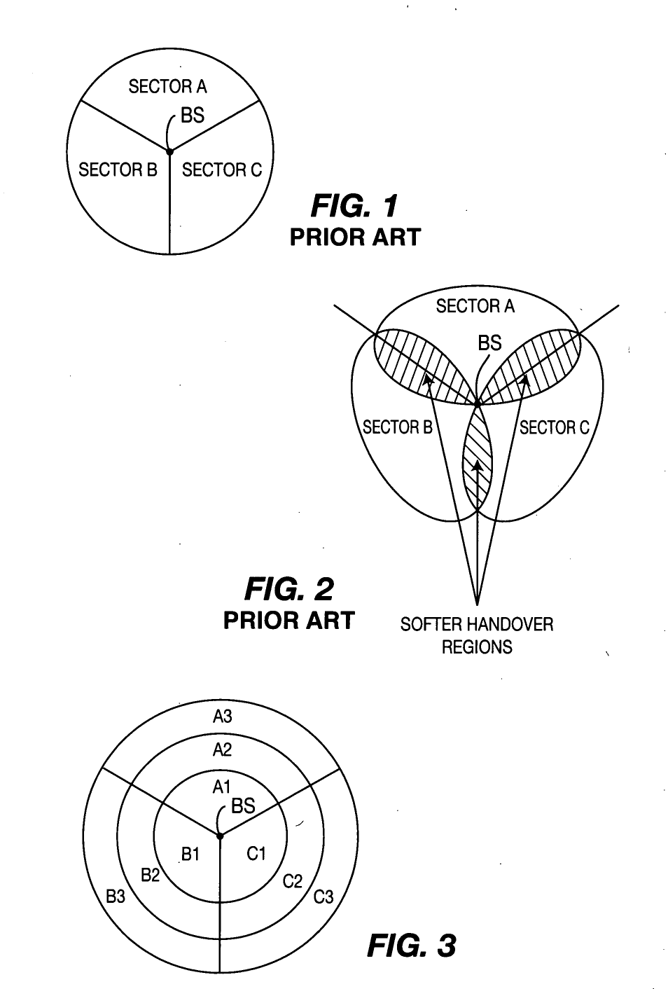

### DETAILED DESCRIPTION OF THE PREFERRED EMBODIMENTS

Hereafter, the terminology “WTRU” includes but is not limited to a user equipment, a mobile station, a fixed or mobile subscriber unit, a pager, or any other type of device capable of operating in a wireless environment. When referred to hereafter, the terminology “base station” includes but is not limited to a Node-B, a site controller, an access point or any other type of interfacing device in a wireless environment.

A wireless communication system comprises a plurality of cells and a plurality of base stations. Typically, each base station serves one cell. In accordance with the present invention, each cell is sectorized in two-dimensions, (i.e., in accordance with an angle in azimuth and a distance from the base station).

Referring to FIG. 3, an example of a cell sectorized in two-dimensions in accordance with the present invention is shown. The cell is divided by three in azimuth, (i.e., sector A, sector B, sector C), and by three in distance from the base station, (i.e., sector 1, sector 2, sector 3). The definition of a sector by both azimuth (i.e., A, B, C), and elevation (i.e., 1, 2, 3), will be referred to hereinafter as a sub-sector, (for example, A1, A2 . . . C2, C3). By sectorizing a cell in two-dimensions, each one of the sectors generated by the azimuth sectorization is further divided into new sub-sectors. In the example shown in FIG. 3, the two-dimensional sectorization creates a total of nine (9) sub-sectors, A1-C3. It should be understood that the number of sub-sectors created by the sectorization scheme shown in FIG. 3 is just an example, not a limitation, and it would be apparent to those skilled in the art that any number of sectors may be implemented.

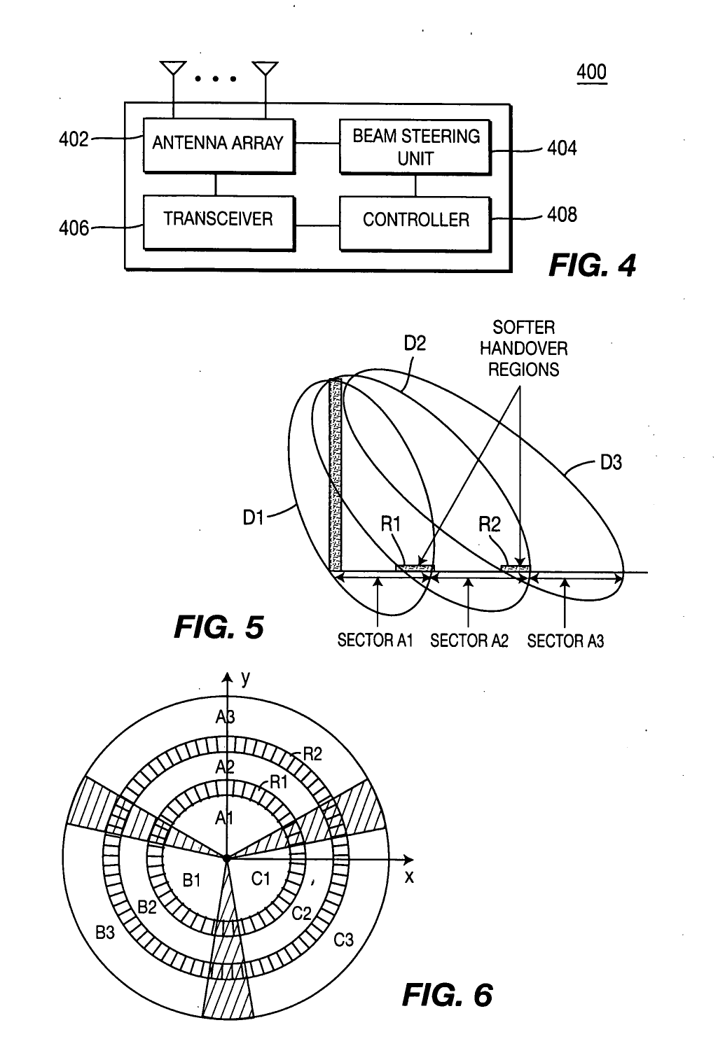

FIG. 4 is a block diagram of a base station 400 in accordance with the present invention. The base station 400 comprises an antenna array 402, a beam steering unit 404, a transceiver 406 and a controller 408. The antenna array 402 comprises a plurality of antennas to generate a plurality of directional beams defined in both azimuth and elevation. The base station 400 communicates with one or more WTRUs (not shown) located in the sectors that the base station 400 covers using at least one of the directional beams.

The beam steering unit 404 switches beam directions to one of the plurality of directional beams. As a WTRU crosses the boundary of sectors, the base station 400 initiates a softer handover procedure while switching a beam to an adjacent beam covering a new sector. The transceiver 406 transmits and receives signals using one of the predefined directional beams. The controller 408 controls overall operation of the base station 400 including softer handover of a communication link from one sector to another sector.

FIG. 5 shows an example of directional beams defined by elevation. A base station generates a plurality of directional beams in different angles in elevation. The cell is divided into a plurality of sectors, (sector A, sector B, sector C), in azimuth, (although this is not specifically shown in FIG. 3). The cell is also divided into a plurality of sectors, (sector 1, sector 2, sector 3), as defined by the distance from the base station, (e.g. elevation). The definition of a sector by both azimuth (i.e., A, B, C), and elevation (i.e., 1, 2, 3), will be referred to hereinafter as a sub-sector, (for example, A1, A2 . . . C2, C3). Directional beams are defined in both azimuth and elevation to cover each of the sub-sectors.

For example, referring to FIG. 5, beam D1 is defined to serve sub-sector A1, beam D2 is defined to serve sub-sector A2, and beam D3 is defined to serve sub-sector A3. FIG. 5 shows only three sub-sectors and three directional beams. However, it should be understood that the configuration shown in FIG. 5 and all other figures in the present invention are provided just as examples, not as limitations, of the present invention, and it should be apparent to those skilled in the art that any other configurations (in terms of number of sectors, number of sub-sectors, or number of beams serving each sector or sub-sector) may be implemented as alternatives.

Adjacent beams overlap each other for softer handover between adjacent sub-sectors. In FIG. 5, beam D1 and beam D2 overlap in the softer handover region R1 to allow softer handover between sub-sector A1 and sub-sector A2, and beam D2 and beam D3 overlap in softer handover region R2 to allow softer handover between sub-sector A2 and sub-sector A3.

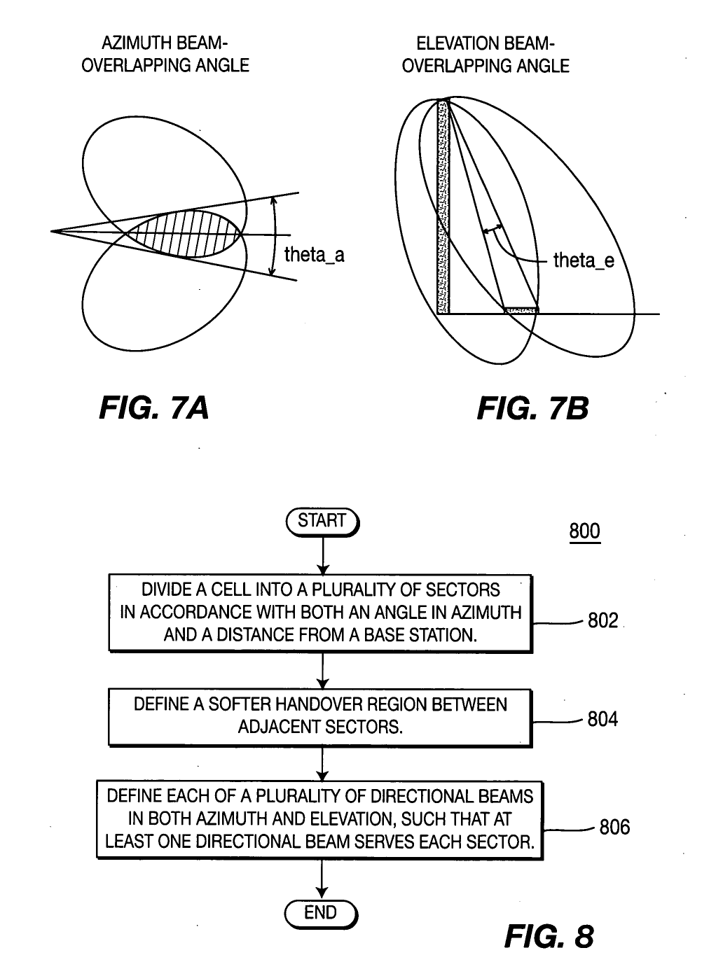

Of course, FIG. 5 shows only overlap between sub-sectors in elevation, whereas overlap between sub-sectors in azimuth also occurs, as shown in FIG. 6. Referring to FIG. 6, softer handover regions (i.e., shaded areas) between sub-sectors that are created by two-dimensional sectorization are shown. Once the desired softer handover regions are defined, the beam-overlapping angle for both azimuth (theta_a) and elevation (theta_e) are determined, and each beam can be defined in terms of an angle in azimuth and elevation to cover each sub-sector. FIGS. 7A and 7B show beam overlapping angles, (theta_a and theta_e), for soft handover both in azimuth (FIG. 7A) and elevation (FIG. 7B).

Once sectorization of a cell and beam overlapping angles are determined, optimal distances between adjacent antenna elements are determined based on the number of sectors in azimuth and elevation, theta_a and theta_e. The distance between the antenna elements dictates the resolution of the beams being projected. The present invention, in contrast, also takes into account elevation. Therefore, in the preferred embodiment, the present invention determines the optimal distance between adjacent antenna elements taking into account both the azimuth and the elevation.

In one embodiment, the procedure of two-dimensional softer handover in accordance with the present invention can be divided into two one-dimensional procedures. Since the two dimensions, (i.e., azimuth and elevation), are orthogonal, a procedure used in the azimuth dimension is repeated for elevation dimension.

The effect of scattering due to multipath propagation often causes significant deviation from the idealized coverage and handover zones. This can be handled by signal measurement comparisons between the existing and potential coverage volumes or areas, as opposed to only relative location to antenna sites. By strategically measuring the actual environment under different settings, a correspondence between the settings and the actual coverage area can be determined. The usage of the beams is then deviated from the ideal based on the actual measured situation.

The change in coverage or handoff zone could be the result of a number of environmental issues, such as multipath fading holes or high interference due to a high density of users interfering with each other. In elevation sectoring, the problem is further complicated by ground bounce. This phenomenon is often encountered in outdoor antenna measurement ranges, where the wave that bounces off the ground can create signal degradation at the receive site and blur the overlap regions. In order to resolve this problem, the antenna height is preferably raised so that the ground sees less signal. The use of fences and trees near the site also reduces the propagation of the ground bounce signal.

FIG. 8 is a flow diagram of a process 800 for managing a cell sectorized in two-dimensions in accordance with the present invention. A cell is divided into a plurality of sub-sectors by an angle in azimuth and by a distance from the base station (step 802). Softer handover regions are defined between adjacent sub-sectors (step 804). A base station is equipped with an array antenna configured to generate a plurality of directional beams which are steerable both in azimuth and elevation. Typically, (although not required), at least one directional beam serves one sub-sector. Once softer handover regions between adjacent sub-sectors are defined, a beam overlapping angle for each sub-sector is calculated, and each beam for covering each sub-sector is defined in both azimuth and elevation (step 806). Communication is performed using one of the predefined directional beams, and a softer handover procedure is initiated if a WTRU enters the handover region between sub-sectors.

Although the features and elements of the present invention are described in the preferred embodiments in particular combinations, each feature or element can be used alone without the other features and elements of the preferred embodiments or in various combinations with or without other features and elements of the present invention.

What is claimed is:

1. A wireless communication system comprising:
a base station comprising an antenna array for generating a plurality of directional beams which are steerable both in azimuth and elevation; and
a cell served by the base station, the cell being sectorized into a plurality of sectors defined in accordance with an angle in azimuth and a distance from the base station, whereby at least one directional beam serves each sector.

2. The wireless communication system of claim 1 wherein the antenna array generates a predefined beam pattern of directional beams which is fixed both in azimuth and elevation in order to serve the plurality of sectors which are also predefined both in azimuth and elevation.

3. The wireless communication system of claim 1 wherein the cell is divided into three (3) sectors in azimuth and divided into three (3) sectors in distance from the base station.

4. The wireless communication system of claim 1 wherein beams serving adjacent sectors overlap each other, whereby softer handover is performed in the overlapping regions.

5. The wireless communication system of claim 1 wherein at least a portion of said plurality of directional beams is adjustable.

6. The wireless communication system of claim 1 wherein at least a portion of said plurality of directional beam is fixed.

7. A cell for which a base station serves in a wireless communication system, comprising:
a plurality of sectors, the sectors being defined both by angle in azimuth and a distance from a base station, whereby at least one directional beam defined in both azimuth and elevation serves each sector.

8. The cell of claim 7 wherein the sectors are fixed both in azimuth and elevation, whereby the sectors are served by a predefined pattern of fixed directional beams.

9. The cell of claim 7 wherein at least a portion of said sectors is served by adjustable beams.

10. The cell of claim 7 wherein at least a portion of said sectors is served by fixed directional beams.

11. The cell of claim 7 wherein the cell is divided into three (3) sectors in azimuth and divided into three (3) sectors in distance from the base station.

12. The cell of claim 7 wherein softer handover regions are defined between adjacent sectors.

13. A method for managing a sectorized cell in a wireless communication system, the method comprising:
dividing a cell into a plurality of sectors, the sectors being defined both by an angle in azimuth and by a distance from a base station;
defining a softer handover region between adjacent sectors;
defining each of a plurality of directional beams in both azimuth and elevation, whereby at least one directional beam serves each sector.

14. The method of claim 13 wherein the sectors are fixed both in azimuth and elevation, whereby the sectors are served by a predefined pattern of fixed directional beams.

15. The method of claim 13 further comprising a step of determining spacing between adjacent antenna sensors for generating the plurality of directional beams based on the number of sectors in azimuth and elevation and overlapping angle of adjacent beams in the softer handover region.

16. The method of claim 13 wherein at least a portion of said plurality of directional beams is adjustable.

17. The method of claim 1 wherein at least a portion of said plurality of directional beam is fixed.

18. A base station for managing a cell sectorized in two-dimensions by an angle in azimuth and a distance from the base station in a wireless communication system, comprising:
an antenna array for generating a plurality of directional beams defined both in azimuth and elevation;
a beam steering unit for steering a beam to one of the predefined directions in azimuth and elevation;
a transmitter/receiver for transmitting and receiving signals; and
a controller for controlling overall operations of the base station, including softer handover of a communication link from one sector to another sector, whereby at least one directional beam covers one sector.

19. The base station of claim 18 wherein the antenna array generates a predefined beam pattern of fixed directional beams which are defined both in azimuth and elevation in order to serve the plurality of sectors which are also predefined both in azimuth and elevation.

20. The base station of claim 18 wherein the cell is divided into three (3) sectors in azimuth and divided into three (3) sectors in distance from the base station.
